(19) United States
(12) Patent Application Publication
(10) Pub. No.: US 2026/0003087 A1
(43) Pub. Date: Jan. 1, 2026

(54) INFORMATION PROCESSING APPARATUS, INFORMATION PROCESSING METHOD, AND INFORMATION PROCESSING PROGRAM

(71) Applicant: FUJIFILM Corporation, Tokyo (JP)

(72) Inventor: Fuyuhiko TERAMOTO, Tokyo (JP)

(73) Assignee: FUJIFILM Corporation, Tokyo (JP)

(21) Appl. No.: 19/242,930

(22) Filed: Jun. 18, 2025

(30) Foreign Application Priority Data
Jun. 28, 2024 (JP) 2024-105281

(51) Int. Cl. G01T 7/00

(52) U.S. Cl. CPC G01T 7/005

(57) ABSTRACT

An information processing apparatus generates first calibration data for correcting a first error included in output data of a radiation detector based on first output data output from the radiation detector by making a tube current value set in the radiation source different in a plurality of stages in a state in which a subject is not present between the radiation source and the radiation detector, and generates second calibration data for correcting a second error included in output data of the radiation detector, based on second output data output from the radiation detector in accordance with a tube current value having a smaller number of stages than the plurality of stages in a state in which a phantom is present between the radiation source and the radiation detector.

### CROSS-REFERENCE TO RELATED APPLICATIONS

This application claims priority from Japanese Patent Application No. 2024-105281, filed on Jun. 28, 2024, the entire disclosure of which is incorporated herein by reference.

### BACKGROUND

### 1. Technical Field

The present disclosure relates to an information processing apparatus, an information processing method, and an information processing program.

### 2. Description of the Related Art

JP2022-113115A discloses a beam hardening correction method in a computed tomography (CT) apparatus (hereinafter, referred to as a “photon counting computed tomography (PCCT) apparatus”) comprising a photon counting radiation detector.

### SUMMARY

For example, in the PCCT apparatus, calibration data may be acquired by performing scanning in a state in which a phantom is disposed. In this case, since there is an operation such as the disposition of the phantom, the calibration data is acquired by an operator such as a maintenance worker operating the PCCT apparatus. Therefore, it is desirable to enable efficient acquisition of the calibration data in the PCCT apparatus.

The present disclosure has been made in view of the above-described circumstances, and an object of the present disclosure is to provide an information processing apparatus, an information processing method, and an information processing program capable of efficiently acquiring calibration data in a PCCT apparatus.

A first aspect relates to an information processing apparatus that controls a photon counting radiation detector and a radiation source, the information processing apparatus comprising: at least one processor, in which the processor configured to: generate first calibration data for correcting a first error included in output data of the radiation detector in accordance with a nonlinear factor caused by the radiation detector, based on first output data output from the radiation detector by emitting radiation from the radiation source to the radiation detector by making a tube current value set in the radiation source different in a plurality of stages in a state in which a subject is not present between the radiation source and the radiation detector; and generate second calibration data for correcting a second error included in output data of the radiation detector in accordance with a nonlinear factor caused by the radiation transmitted through the subject, based on second output data output from the radiation detector by emitting the radiation from the radiation source to the radiation detector in accordance with a tube current value having a smaller number of stages than the plurality of stages in a state in which a phantom is present between the radiation source and the radiation detector.

A second aspect relates to the information processing apparatus according to the first aspect, in which the processor is configured to correct the first error of third output data output from the radiation detector by emitting the radiation from the radiation source to the radiation detector in a state in which the subject is present between the radiation source and the radiation detector, using the first calibration data, and correct the second error of the third output data using the second calibration data.

A third aspect relates to the information processing apparatus according to the first or second aspect, in which the processor is configured to make the tube current value different for each scanning in a plurality of times of scanning in a case of generating the first calibration data.

A fourth aspect relates to the information processing apparatus according to any one of the first to third aspects, in which the processor is configured to make the tube current value different for each scanning in a plurality of times of scanning in a case of generating the second calibration data.

A fifth aspect relates to the information processing apparatus according to the first or second aspect, in which the processor is configured to set the number of times of scanning in a case of generating the first calibration data or the second calibration data to be smaller than the number of times in a case of making the tube current value different for each scanning in a plurality of times of scanning, by making the tube current value different in a single time of scanning in a case of generating the first calibration data or the second calibration data.

A sixth aspect relates to an information processing method executed by a processor included in an information processing apparatus that controls a photon counting radiation detector and a radiation source and that includes at least one processor, the information processing method comprising: generating first calibration data for correcting a first error included in output data of the radiation detector in accordance with a nonlinear factor caused by the radiation detector, based on first output data output from the radiation detector by emitting radiation from the radiation source to the radiation detector by making a tube current value set in the radiation source different in a plurality of stages in a state in which a subject is not present between the radiation source and the radiation detector; and generating second calibration data for correcting a second error included in output data of the radiation detector in accordance with a nonlinear factor caused by the radiation transmitted through the subject, based on second output data output from the radiation detector by emitting the radiation from the radiation source to the radiation detector in accordance with a tube current value having a smaller number of stages than the plurality of stages in a state in which a phantom is present between the radiation source and the radiation detector.

A seventh aspect relates to an information processing program causing a processor included in an information processing apparatus that controls a photon counting radiation detector and a radiation source and that includes at least one processor, to execute a process comprising: generating first calibration data for correcting a first error included in output data of the radiation detector in accordance with a nonlinear factor caused by the radiation detector, based on first output data output from the radiation detector by emitting radiation from the radiation source to the radiation detector by making a tube current value set in the radiation source different in a plurality of stages in a state in which a subject is not present between the radiation source and the radiation detector; and generating second calibration data for correcting a second error included in output data of the radiation detector in accordance with a nonlinear factor caused by the radiation transmitted through the subject, based on second output data output from the radiation detector by emitting the radiation from the radiation source to the radiation detector in accordance with a tube current value having a smaller number of stages than the plurality of stages in a state in which a phantom is present between the radiation source and the radiation detector.

According to the present disclosure, it is possible to efficiently acquire the calibration data in the PCCT apparatus.

### BRIEF DESCRIPTION OF THE DRAWINGS

FIG. 1 is a schematic diagram showing an example of a configuration of a tomographic image capturing system.

FIG. 2 is a block diagram showing an example of a hardware configuration of a console.

FIG. 3 is a block diagram showing an example of a functional configuration of the console.

FIG. 4 is a diagram showing first imaging control.

FIG. 5 is a diagram showing second imaging control.

FIG. 6 is a flowchart showing an example of first calibration data generation processing.

FIG. 7 is a flowchart showing an example of second calibration data generation processing.

FIG. 8 is a flowchart showing an example of tomographic image generation processing.

### DETAILED DESCRIPTION

Hereinafter, an embodiment for carrying out the technology of the present disclosure will be described in detail with reference to the accompanying drawings.

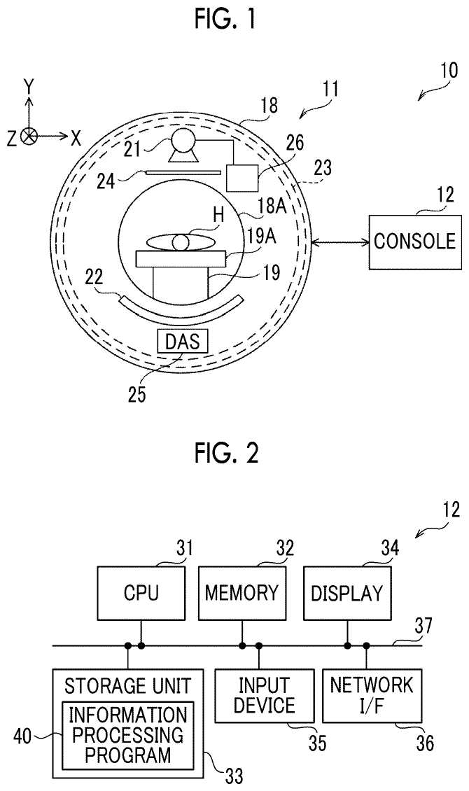

First, a configuration of a tomographic image capturing system 10 will be described with reference to FIG. 1. As shown in FIG. 1, the tomographic image capturing system 10 according to the present embodiment comprises a CT apparatus 11 and a console 12.

The CT apparatus 11 obtains a tomographic image of a subject H by imaging the subject H using X-rays as an example of radiation. The CT apparatus 11 comprises a gantry 18 and an examination table device 19. FIG. 1 is a diagram in which a gantry 18 and the examination table device 19 are viewed from the front side. The examination table device 19 comprises a top plate 19A on which the subject H can be placed in a decubitus posture. In the following description, a longitudinal direction of the top plate 19A will be referred to as a Z axis direction, a lateral direction of the top plate 19A will be referred to as an X axis direction, and a vertical direction will be referred to as a Y axis direction. The top plate 19A can move in the Z axis direction in a state of being kept horizontal. The gantry 18 has an annular shape as a whole, and a circular opening portion 18A having a diameter larger than a width of the top plate 19A is formed at the center thereof. During the imaging, the top plate 19A on which the subject H is placed is moved in the Z axis direction with respect to the gantry 18, to enter the opening portion 18A. The imaging is performed while moving the top plate 19A with respect to the gantry 18.

A radiation source 21, a radiation detector 22, and a frame 23 are disposed inside the gantry 18. The radiation source 21 emits the radiation toward the subject H. The radiation detector 22 detects the radiation transmitted through the subject H. The radiation transmitted through the subject His attenuated by interaction (for example, absorption and scattering of the radiation) with structures such as organs and bones inside the body of the subject H. The structures each have an attenuation coefficient for the radiation peculiar to the structures, and the radiation transmitted through the structures carries information reflecting the physical properties of the structures. The radiation detector 22 detects the radiation in which physical properties of the structure in the body of the subject H are reflected. The radiation detector 22 has a detection surface in which detection elements are two-dimensionally arranged, and outputs a detection signal for each of the detection elements. For this reason, the radiation detector 22 can detect the radiation at each transmission position transmitted through the structure of the subject H. In addition, the radiation detector 22 has a substantially arc shape in accordance with a curvature of the gantry 18, and the detection surface is also curved. The radiation detector 22 is an example of a photon counting radiation detector, and is a radiation detector that can count the number of photons of incident X-rays.

The radiation source 21 and the radiation detector 22 are disposed at positions facing each other in the gantry 18 and are rotated around the Z axis while maintaining a facing posture. The frame 23 has an annular shape and supports the radiation source 21 and the radiation detector 22 in a rotatable manner. During the imaging, the gantry 18 acquires the detection signals by the radiation detector 22 at a plurality of positions in a circumferential direction around the Z axis corresponding to the body axis of the subject H while rotating the radiation source 21 and the radiation detector 22 around the subject H on the top plate 19A. During the imaging, the top plate 19A also moves in the Z axis direction in synchronization with the rotation of the radiation source 21 and the radiation detector 22.

A data acquisition system (DAS) 25 collects the detection signal output by the radiation detector 22, generates output data at each position around the Z axis based on the collected detection signal, and outputs the generated output data to the console 12. In a case in which the subject H is present between the radiation source 21 and the radiation detector 22, this output data is projection data in which the subject H is projected. Hereinafter, the output data output by the DAS 25 toward the console 12 will be referred to as output data of the radiation detector 22.

An irradiation field limiter 24 (also referred to as a collimator) that limits an irradiation field of radiation is disposed in front of the radiation source 21 in an irradiation direction. The irradiation field limiter 24 has an irradiation opening of which a contour is defined by a plurality of shielding plates for shielding the radiation, and a size of the irradiation opening can be changed by moving the shielding plates. A voltage is supplied to the radiation source 21 from a high-voltage generator 26. The radiation source 21 and the radiation detector 22 are electrically connected to the frame 23 by a slip ring method, and, for example, power supply, transmission and reception of data, and the like are performed via a slip ring. The connection using the slip ring method allows the radiation source 21 and the radiation detector 22 to perform helical scan imaging in which imaging is performed while rotating in one direction without reversing the rotation direction.

The console 12 controls the radiation source 21 and the radiation detector 22 via a control device (not shown) included in the gantry 18. The console 12 is an example of an information processing apparatus that controls a photon counting radiation detector and a radiation source. The imaging conditions of the CT apparatus 11 are set by the operation from the console 12. The imaging conditions include an irradiation condition of the radiation of the radiation source 21, an imaging range, and the like. The irradiation condition of the radiation includes a tube voltage (unit: kv) to be applied to the radiation source 21, a tube current (unit: mA), and an irradiation time (unit: msec) of the radiation. The imaging range is adjusted, for example, by changing the size of the irradiation opening of the irradiation field limiter 24 in the X-Y plane, and is adjusted by changing a movement range of the top plate 19A in the Z axis direction.

A hardware configuration of the console 12 according to the present embodiment will be described with reference to FIG. 2. Examples of the console 12 include a computer, such as a personal computer or a server computer. As shown in FIG. 2, the console 12 includes a central processing unit (CPU) 31, a memory 32 as a temporary storage area, and a non-volatile storage unit 33. Further, the console 12 includes a display 34 such as a liquid crystal display, an input device 35 such as a keyboard and a mouse, and a network interface (I/F) 36 connected to the CT apparatus 11. The CPU 31, the memory 32, the storage unit 33, the display 34, the input device 35, and the network I/F 36 are connected to a bus 37. The CPU 31 is an example of a processor according to the technology of the present disclosure.

The storage unit 33 is implemented by using a hard disk drive (HDD), a solid state drive (SSD), a flash memory, and the like. An information processing program 40 is stored in the storage unit 33 as a storage medium. The CPU 31 reads out the information processing program 40 from the storage unit 33, loads the read out information processing program 40 into the memory 32, and executes the loaded information processing program 40.

In the CT apparatus 11 according to the present embodiment, the output data of the radiation detector 22 includes an error (hereinafter, referred to as a “first error”) corresponding to a nonlinear factor caused by the radiation detector 22. Examples of the first error include an error caused by pile-up, which is a nonlinear factor.

Further, the output data of the radiation detector 22 also includes an error caused by a factor other than the radiation detector 22. Specifically, the output data of the radiation detector 22 includes an error (hereinafter, referred to as a “second error”) caused by a nonlinear factor caused by the radiation transmitted through the subject H. Examples of the second error include an error caused by beam hardening, which is a nonlinear factor.

The console 12 according to the present embodiment has a function of generating calibration data for correcting the first error (hereinafter, referred to as “first calibration data”) and calibration data for correcting the second error (hereinafter, referred to as “second calibration data”).

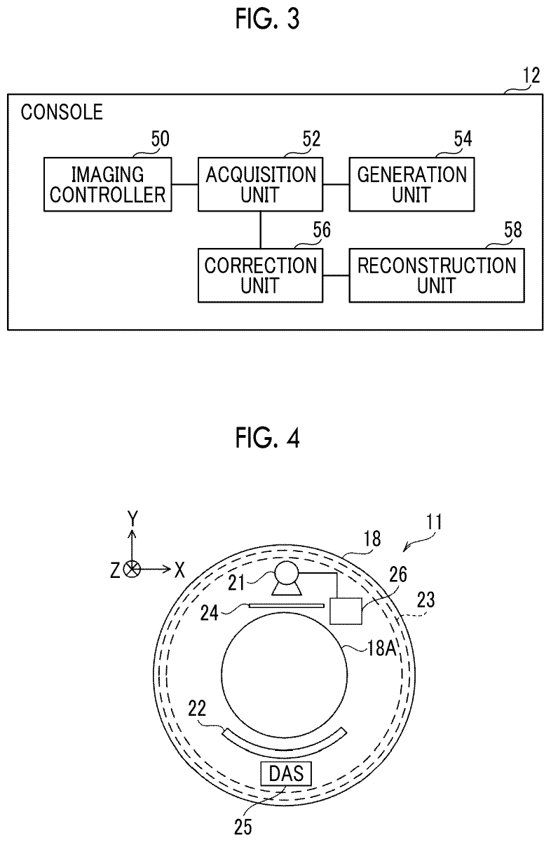

Next, a functional configuration of the console 12 will be described with reference to FIG. 3. As shown in FIG. 3, the console 12 includes an imaging controller 50, an acquisition unit 52, a generation unit 54, a correction unit 56, and a reconstruction unit 58. The CPU 31 executes the information processing program 40 to function as the imaging controller 50, the acquisition unit 52, the generation unit 54, the correction unit 56, and the reconstruction unit 58.

As an example, as shown in FIG. 4, the imaging controller 50 performs control of performing the imaging in a state in which the subject H and the examination table device 19 are not present between the radiation source 21 and the radiation detector 22 (hereinafter, referred to as “first imaging control”). In the first imaging control, the imaging controller 50 emits the radiation from the radiation source 21 to the radiation detector 22 by making the tube current value set in the radiation source 21 different in a plurality of stages. This tube current value is set, for example, at the time of shipment or set by a maintenance worker in a case in which the first imaging control is performed.

For example, in the first imaging control, the imaging controller 50 makes the tube current value different in a plurality of stages within a range of being equal to or more than a lower limit value and equal to or less than an upper limit value in a case of being used in actual imaging. In the present embodiment, in the first imaging control, the imaging controller 50 performs a single time of scanning with one tube current value, and makes the tube current value different for each scanning in a plurality of times of scanning. The DAS 25 collects the detection signal output by the radiation detector 22 for each scanning and outputs the output data generated based on the collected detection signal to the console 12. That is, in the first imaging control, the output data of the radiation detector 22 corresponding to each of the plurality of stages of the tube current value is obtained. Hereinafter, the output data output from the radiation detector 22 by the first imaging control will be referred to as “first output data”. The first output data is used for generating the first calibration data by the generation unit 54 described below. That is, the imaging controller 50 makes the tube current value different for each scanning in the plurality of times of scanning in a case of generating the first calibration data. In the present embodiment, the single time of scanning means that the imaging is performed while the radiation source 21 and the radiation detector 22 are rotated by 360° around the Z axis.

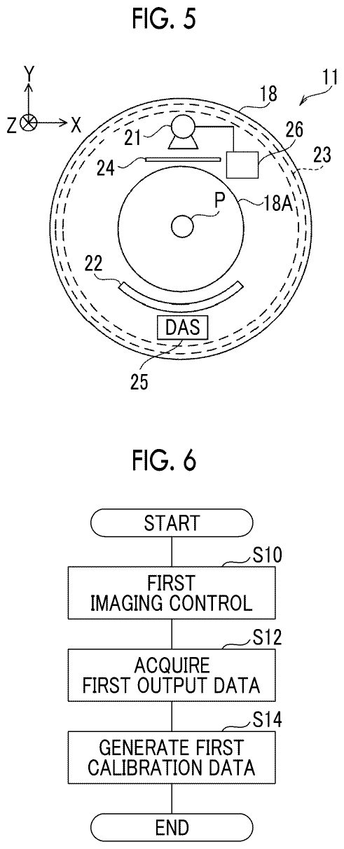

As an example, as shown in FIG. 5, the imaging controller 50 performs control of performing the imaging in a state in which a phantom P is present between the radiation source 21 and the radiation detector 22 (hereinafter, referred to as “second imaging control”). The phantom P simulates the subject H, and a size, a shape, a material, and the like thereof including a thickness, a length, a width, and the like are known. In the second imaging control, the phantom P is installed by a jig (not shown) or the like.

In the second imaging control, the imaging controller 50 causes the radiation source 21 to emit the radiation to the radiation detector 22 in accordance with the tube current value having the number of stages smaller than the number of stages of the tube current value in the first imaging control. In the present embodiment, as an example, a case will be described in which the number of stages of the tube current value in the second imaging control is two or more, but the number of stages of the tube current value in the second imaging control may be one.

For example, in the second imaging control, the imaging controller 50 sets the tube current value having the number of stages smaller than the number of stages of the tube current value in the first imaging control to the radiation source 21, by using a part of the tube current values among the tube current values in the plurality of stages used in the first imaging control. In the present embodiment, in the second imaging control, the imaging controller 50 performs a single time of scanning with one tube current value, and makes the tube current value different for each scanning in a plurality of times of scanning.

The DAS 25 collects the detection signal output by the radiation detector 22 for each scanning and outputs the output data generated based on the collected detection signal to the console 12. That is, in the second imaging control, the output data of the radiation detector 22 corresponding to each of the plurality of stages of the tube current value is obtained. Hereinafter, the output data output from the radiation detector 22 by the second imaging control will be referred to as “second output data”. The second output data is used for generating the second calibration data by the generation unit 54 described below. That is, the imaging controller 50 makes the tube current value different for each scanning in the plurality of times of scanning in a case of generating the second calibration data.

As an example, as shown in FIG. 1, the imaging controller 50 performs control of performing the imaging in a state in which the subject H is present between the radiation source 21 and the radiation detector 22 (hereinafter, referred to as “third imaging control”). In the third imaging control, the imaging controller 50 sets the tube current value in accordance with the imaging conditions in the radiation source 21. The imaging conditions are set by a technician or the like in accordance with the subject H of an examination target, a part of the examination target, and an examination purpose. Hereinafter, the output data output from the radiation detector 22 by the third imaging control will be referred to as “third output data”.

The acquisition unit 52 acquires the first output data obtained by the first imaging control, from the DAS 25. In addition, the acquisition unit 52 acquires the second output data obtained by the second imaging control, from the DAS 25. In addition, the acquisition unit 52 acquires the third output data obtained by the third imaging control, from the DAS 25. Further, the acquisition unit 52 acquires, from the storage unit 33, the first calibration data and the second calibration data corresponding to the tube current value included in the imaging conditions in the third imaging control, among the first calibration data and the second calibration data stored in the storage unit 33 by the generation unit 54 described below.

The generation unit 54 generates the first calibration data for correcting the first error included in the output data of the radiation detector 22 based on the first output data acquired by the acquisition unit 52. As described above, since the first output data is obtained in a state in which the subject H is not present between the radiation source 21 and the radiation detector 22, it is considered that a projection value based on the first output data becomes zero in a case in which the first output data does not include the first error. Therefore, the generation unit 54 generates the first calibration data such that the projection value based on the first output data becomes zero in a case in which the first output data is subtracted for each detection element of the radiation detector 22. The generation unit 54 generates the first calibration data for each tube current value and stores the tube current value and the first calibration data, in the storage unit 33, in association with each other. It should be noted that, in a case in which the tube current value is input, the generation unit 54 may store the first calibration data in the storage unit 33 in a form of a function that outputs the first calibration data corresponding to the input tube current value.

In addition, the generation unit 54 generates the second calibration data for correcting the second error included in the output data of the radiation detector 22 based on the second output data acquired by the acquisition unit 52. As described above, the phantom P used in a case in which the second output data is acquired is a phantom that simulates the subject H, and the size, the shape, the material, and the like thereof including the thickness, the length, the width, and the like are known. In addition, an incidence angle of the radiation with respect to the phantom P and a radiation dose in a case in which the second output data is acquired are also known. Therefore, a theoretical value of the second output data in a case in which the second output data does not include the second error can be calculated in advance. Therefore, the generation unit 54 derives, as the second calibration data, a correction coefficient such that a measured value of the second output data matches the theoretical value of the second output data for each detection element of the radiation detector 22. The generation unit 54 generates the second calibration data for each tube current value and stores the tube current value and the second calibration data, in the storage unit 33, in association with each other. It should be noted that, in a case in which the tube current value is input, the generation unit 54 may store the second calibration data in the storage unit 33 in a form of a function that outputs the second calibration data corresponding to the input tube current value.

The correction unit 56 corrects the first error of the third output data, which is acquired by the acquisition unit 52, using the first calibration data, and corrects the second error of the third output data using the second calibration data. Specifically, the correction unit 56 first corrects the first error of the third output data by subtracting the first calibration data from the third output data for each corresponding detection element. Then, the correction unit 56 corrects the second error by multiplying the third output data after the correction of the first error by the second calibration data for each corresponding detection element.

The reconstruction unit 58 generates the tomographic image by reconstructing the tomographic image based on the third output data after the correction performed by the correction unit 56. The tomographic image is reconstructed based on the third output data by using, for example, a filter correction back projection method.

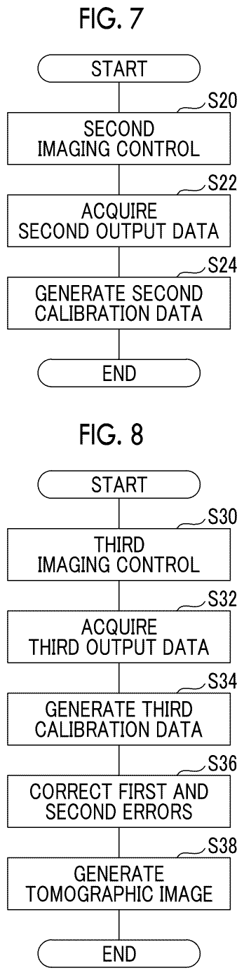

Hereinafter, the operation of the console 12 will be described with reference to FIGS. 6 to 8. The CPU 31 executes the information processing program 40 to execute first calibration data generation processing shown in FIG. 6, second calibration data generation processing shown in FIG. 7, and tomographic image generation processing shown in FIG. 8. The first calibration data generation processing is executed at a regular timing such as once a day and in a case in which an instruction to start the execution is input by the maintenance worker. The second calibration data generation processing is executed in a case in which an instruction to start the execution is input by the maintenance worker. The tomographic image generation processing is executed in a case in which an instruction to start the execution is input by the technician.

In step S10 of FIG. 6, as described above, the imaging controller 50 performs the first imaging control of performing the imaging in a state in which the subject H is not present between the radiation source 21 and the radiation detector 22. In step S12, the acquisition unit 52 acquires the first output data obtained by the first imaging control performed in step S10, from the DAS 25.

In step S14, the generation unit 54 generates the first calibration data for correcting the first error included in the output data of the radiation detector 22 based on the first output data acquired in step S12, as described above. Then, the generation unit 54 stores the tube current value and the first calibration data, in the storage unit 33, in association with each other. In a case in which the processing of step S14 ends, the first calibration data generation processing ends.

In step S20 of FIG. 7, the imaging controller 50 performs the second imaging control for performing the imaging in a state in which the phantom P is present between the radiation source 21 and the radiation detector 22, as described above. In step S22, the acquisition unit 52 acquires the second output data obtained by the second imaging control performed in step S20, from the DAS 25.

In step S24, the generation unit 54 generates the second calibration data for correcting the second error included in the output data of the radiation detector 22 based on the second output data acquired in step S22, as described above. Then, the generation unit 54 stores the tube current value and the second calibration data, in the storage unit 33, in association with each other. In a case in which the processing of step S24 ends, the second calibration data generation processing ends.

In step S30 of FIG. 8, the imaging controller 50 performs the third imaging control of performing the imaging in a state in which the subject His present between the radiation source 21 and the radiation detector 22, as described above. In step S32, the acquisition unit 52 acquires the third output data obtained by the third imaging control performed in step S30, from the DAS 25. In step S34, the acquisition unit 52 acquires the first calibration data and the second calibration data corresponding to the tube current value included in the imaging condition in the third imaging control, from the storage unit 33.

In step S36, as described above, the correction unit 56 corrects the first error of the third output data acquired in step S32 using the first calibration data acquired in step S34, and corrects the second error of the third output data using the second calibration data acquired in step S34. In step S38, the reconstruction unit 58 generates the tomographic image by reconstructing the tomographic image based on the third output data after the correction performed in step S36. In a case in which the processing of step S38 ends, the tomographic image generation processing ends.

As described above, according to the present embodiment, in the second imaging control in which the phantom P is disposed by the maintenance worker or the like, the number of stages of the tube current value is set to be smaller than the number of stages of the tube current value in the first imaging control. As a result, a required time for the second imaging control is shortened as compared with a case in which the number of stages of the tube current value in the second imaging control is the same as that in the first imaging control. Therefore, the calibration data in the PCCT apparatus can be efficiently acquired.

It should be noted that, in the above-described embodiment, a case has been described in which the imaging controller 50 performs a single time of scanning with one tube current value in a case of generating the first calibration data and makes the tube current value different for each scanning in the plurality of times of scanning, but the disclosed technology is not limited to this aspect. The imaging controller 50 may set the number of times of scanning in a case of generating the first calibration data to be smaller than the number of times in a case of making the tube current value different for each scanning in the plurality of times of scanning, by making the tube current value different in a plurality of stages in a single time of scanning in a case of generating the first calibration data. For example, the imaging controller 50 may make the tube current value different each time the radiation source 21 and the radiation detector 22 are rotated by a predetermined amount of rotation around the Z axis in a single time of scanning in a case of generating the first calibration data. As a result, it is possible to shorten a time required for the generation processing of the first calibration data. Similarly, the imaging controller 50 may set the number of times of scanning in a case of generating the second calibration data to be smaller than the number of times in a case of making the tube current value different for each scanning in the plurality of times of scanning, by making the tube current value different in a plurality of stages in a single time of scanning in a case of generating the second calibration data.

In addition, at least one of the functional units included in the console 12 in the above-described embodiment may be included in another device such as the control device included in the gantry 18.

In addition, in the above-described embodiment, for example, various processors shown below can be used as a hardware structure of a processing unit that executes various types of processing, such as each functional unit of the console 12. The various processors include, in addition to a CPU that is a general purpose processor functioning as various processing units by executing software (program) as described above, a programmable logic device (PLD) that is a processor of which a circuit configuration can be changed after manufacture such as an FPGA, a dedicated electric circuit that is a processor having a circuit configuration dedicatedly designed to execute specific processing such as an application specific integrated circuit (ASIC), and the like.

One processing unit may be configured by one of the various processors or may be configured by combining two or more processors of the same type or different types (for example, by combining a plurality of FPGAs or combining a CPU and an FPGA). Further, a plurality of processing units may be configured by one processor.

A first example of the configuration in which the plurality of processing units are configured by one processor is a form in which one processor is configured by combining one or more CPUs and the software and this processor functions as the plurality of processing units, as represented by computers such as a client and a server. A second example thereof is a form in which a processor that implements the function of the entire system including the plurality of processing units by one integrated circuit (IC) chip is used, as represented by a system-on-chip (SoC) or the like. In this way, various processing units are configured by one or more of the various processors as the hardware structure.

Further, as the hardware structure of the various processors, more specifically, an electric circuit (circuitry) in which circuit elements such as semiconductor elements are combined can be used.

In addition, in the above-described embodiment, the aspect has been described in which the information processing program 40 is stored (installed) in the storage unit 33 in advance, but the present disclosure is not limited to this. The information processing program 40 may be provided in a form of being recorded in the recording medium such as a compact disc read only memory (CD-ROM), a digital versatile disc read only memory (DVD-ROM), and a universal serial bus (USB) memory. In addition, the information processing program 40 may be provided in a form being downloaded from an external device via a network.

What is claimed is:

1. An information processing apparatus that controls a photon counting radiation detector and a radiation source, the information processing apparatus comprising:
at least one processor,
wherein the processor configured to:
generate first calibration data for correcting a first error included in output data of the radiation detector in accordance with a nonlinear factor caused by the radiation detector, based on first output data output from the radiation detector by emitting radiation from the radiation source to the radiation detector by making a tube current value set in the radiation source different in a plurality of stages in a state in which a subject is not present between the radiation source and the radiation detector; and
generate second calibration data for correcting a second error included in output data of the radiation detector in accordance with a nonlinear factor caused by the radiation transmitted through the subject, based on second output data output from the radiation detector by emitting the radiation from the radiation source to the radiation detector in accordance with a tube current value having a smaller number of stages than the plurality of stages in a state in which a phantom is present between the radiation source and the radiation detector.

2. The information processing apparatus according to claim 1,
wherein the processor is configured to correct the first error of third output data output from the radiation detector by emitting the radiation from the radiation source to the radiation detector in a state in which the subject is present between the radiation source and the radiation detector, using the first calibration data, and correct the second error of the third output data using the second calibration data.

3. The information processing apparatus according to claim 1,
wherein the processor is configured to make the tube current value different for each scanning in a plurality of times of scanning in a case of generating the first calibration data.

4. The information processing apparatus according to claim 1,
wherein the processor is configured to make the tube current value different for each scanning in a plurality of times of scanning in a case of generating the second calibration data.

5. The information processing apparatus according to claim 1,
wherein the processor is configured to set the number of times of scanning in a case of generating the first calibration data or the second calibration data to be smaller than the number of times in a case of making the tube current value different for each scanning in a plurality of times of scanning, by making the tube current value different in a single time of scanning in a case of generating the first calibration data or the second calibration data.

6. An information processing method executed by a processor included in an information processing apparatus that controls a photon counting radiation detector and a radiation source and that includes at least one processor, the information processing method comprising:
generating first calibration data for correcting a first error included in output data of the radiation detector in accordance with a nonlinear factor caused by the radiation detector, based on first output data output from the radiation detector by emitting radiation from the radiation source to the radiation detector by making a tube current value set in the radiation source different in a plurality of stages in a state in which a subject is not present between the radiation source and the radiation detector; and
generating second calibration data for correcting a second error included in output data of the radiation detector in accordance with a nonlinear factor caused by the radiation transmitted through the subject, based on second output data output from the radiation detector by emitting the radiation from the radiation source to the radiation detector in accordance with a tube current value having a smaller number of stages than the plurality of stages in a state in which a phantom is present between the radiation source and the radiation detector.

7. A non-transitory computer-readable storage medium storing an information processing program causing a processor included in an information processing apparatus that controls a photon counting radiation detector and a radiation source and that includes at least one processor, to execute a process comprising:
generating first calibration data for correcting a first error included in output data of the radiation detector in accordance with a nonlinear factor caused by the radiation detector, based on first output data output from the radiation detector by emitting radiation from the radiation source to the radiation detector by making a tube current value set in the radiation source different in a plurality of stages in a state in which a subject is not present between the radiation source and the radiation detector; and
generating second calibration data for correcting a second error included in output data of the radiation detector in accordance with a nonlinear factor caused by the radiation transmitted through the subject, based on second output data output from the radiation detector by emitting the radiation from the radiation source to the radiation detector in accordance with a tube current value having a smaller number of stages than the plurality of stages in a state in which a phantom is present between the radiation source and the radiation detector.
